(19) United States
(12) Patent Application Publication
(10) Pub. No.: US 2026/0312807 A1
(43) Pub. Date: Oct. 8, 2026

(54) GENERATION OF PRIME NUMBERS SUBJECT TO AN AUXILIARY CONDITION IN CRYPTOGRAPHIC APPLICATIONS

(71) Applicant: CRYPTOGRAPHY RESEARCH, INC., San Jose, CA (US)

(72) Inventors: Qinglai Xiao, Espoo (FI); Michael Alexander Hamburg, Rosmalen (NL)

(21) Appl. No.: 19/635,143

(22) Filed: Mar. 31, 2026

Related U.S. Application Data
(60) Provisional application No. 63/783,047, filed on Apr. 3, 2025.

(51) Int. Cl. H04L 9/30; G06F 7/72

(52) U.S. Cl. CPC H04L 9/3033; G06F 7/722; H04L 9/3093

(57) ABSTRACT

Aspects of the present disclosure involve a method, a system and a computer readable memory to generate and use prime numbers in cryptographic applications using operations that include selecting a subset of prime numbers and identifying polynomial function(s) that (i) have no roots modulo each of the subset of prime numbers and (ii) generate outputs that are congruent to a predetermined value modulo a reference value. The operations further include selecting one or more input values, applying the one or more polynomial function(s) to the one or more input values to generate a candidate number, determining that the candidate number is a prime number, and computing using the determined prime number, an output of a cryptographic operation.

### CLAIM OF PRIORTY

The present application claims the benefit under 35 U.S.C. § 119 (e) of U.S. Provisional Patent Application No. 63/783,047 filed Apr. 3, 2025, the contents of which are being incorporated in their entirety by reference herein.

### TECHNICAL FIELD

The disclosure pertains to cryptographic computing applications, more specifically to improving efficiency of cryptographic operations.

### BRIEF DESCRIPTION OF THE DRAWINGS

The present disclosure will be understood more fully from the detailed description given below and from the accompanying drawings of various implementations of the disclosure.

FIG. 1A illustrates an example computing architecture that supports polynomial-based generation of constrained prime numbers in cryptographic applications, in accordance with one or more aspects of the present disclosure.

FIG. 1B illustrates another example computing architecture that supports polynomial-based generation of constrained prime numbers in cryptographic applications, in accordance with one or more aspects of the present disclosure.

FIG. 2 depicts schematically example operations performed as part of efficient generation of constrained prime numbers and deployment of the generated prime numbers in cryptographic applications, in accordance with one or more aspects of the present disclosure.

FIG. 3 depicts a flow diagram of an illustrative method of efficient generation of constrained prime numbers and deployment of the generated prime numbers in cryptographic applications, in accordance with one or more aspects of the present disclosure.

FIG. 4 is a block diagram illustrating an example computing platform capable of supporting of efficient generation of constrained prime numbers and deployment of the generated prime numbers in cryptographic applications, in accordance with one or more aspects of the present disclosure.

FIG. 5 depicts a block diagram of an example computer system operating in accordance with one or more aspects of the present disclosure.

### DETAILED DESCRIPTION

In public-key cryptography systems, a processing device may have various components/modules used for cryptographic operations on input messages, which are typically represented via large integers. Cryptographic algorithms often involve modular arithmetic operations with modulus M, in which the set of all integers Z is wrapped around a circle of length M (the set Z_{M}), so that any two numbers that differ by M (or any other integer multiple of M) are congruent to (and treated as) the same number within Z_{M}. Cryptographic applications—such as the Rivest-Shamir-Adelman (RSA) algorithm, digital signature algorithms (DSA), Diffie-Hellman key exchange (DHKE) algorithms, Elliptic Curve Cryptography (ECC) algorithms, and the like—exploit the fact that solving an integer factorization problem, a discrete logarithm problem, an elliptic curve discrete logarithm problem, and/or the like, involves operations that are prohibitively difficult (for large moduli M) to perform on a classical computer.

In one example of computing devices deploying Rivest-Shamir-Adelman (RSA) public key/private key protocols, a cryptographic application (of an intended recipient of an encoded message) may perform private/public key generation by selecting two (or more) large prime numbers, e.g., p and q, adopting a (simple to store) public exponent e (often 3≡2¹+1, 17≡2⁴+1, or 65537≡2¹⁶+1) and computing a secret (decryption) exponent d based on the public (encryption) exponent e and the selected numbers p and q. The numbers e and N=p·q are revealed as part of the public key whereas p, q, and d are stored in secret by the recipient as parts of the private key. A sender of message m may convert the message into a ciphertext using modular exponentiation, c=m^{e} mod N, and send the encrypted ciphertext c over a public communication channel. The recipient of the ciphertext may then decipher the ciphertext by applying another modular exponentiation, m=c^{d} mod N, provided that the value of the decryption exponent d is selected is such a way that e·d=1 mod N*, where N*=(p−1)·(q−1) (Euler's totient function). Alternatively, as often used, N* may be taken as the least common multiplier of p−1 and q−1 (Carmichael's totient function). Because recovering the private exponent d requires factorizing a large public number N into its prime number multipliers p and q—a prohibitively-heavy computational task for large N—the encrypted message m remains safe even if its ciphertext c becomes known to others.

Prime numbers (e.g., p and q) used in cryptographic applications (e.g., employing the Rivest-Shamir-Adleman key exchange, the Diffie-Hellman key exchange, the Digital Signature algorithms, elliptic curve applications, and the like) may be generated based on any known methods, such as Atkin-Bernstein sieve, sieve of Eratosthenes, Joye-Paillier method, or the like. Candidate prime numbers can be tested for primality using any known tests, such as the Fermat tests, the Euler tests, the Pocklington test, the Baillie-Pomerance-Selfridge-Wagstaff test, the Miller-Rabin test, or the like. Such tests, however, often have a rather low yield of prime numbers. For example, the Miller-Rabin primality test may require, on average, about 700 attempts to identify one 1024-bit prime number. Algorithms that deterministically search for prime numbers based on failed attempts may be capable of finding prime numbers faster, but may be vulnerable to power analysis attacks, such as simple power analysis (SPA) attacks, differential power analysis (DPA) attacks, and/or the like. A side-channel attacker intercepting hardware emissions may be capable of acquiring additional information with each iteration of the generating algorithm until the attacker is able to ascertaine what candidate numbers are being tested, leading to a potential exposure of the eventual identified prime numbers.

Additionally, in some cryptographic applications, such as Finite Field Diffie-Hellman (FFDH) applications and applications that deploy Finite Field Digital Signature algorithms (FFDSA), a generated prime number p may have to be subject to an additional constraint, e.g., that p−1 be divisible by an auxiliary prime number Q. In other words, the prime number may have to be of the form, p=2Qy+1 (factor 2 reflecting the fact that p−1 is an even number, since all prime numbers other than number 2 are odd), where y may be arbitrary. Finding prime numbers that are subject to such additional auxiliary constraints (referred to as “constrained prime numbers” herein) has a yield that is still lower than finding unconstrained prime numbers.

Aspects and implementations of the instant disclosure address these and other challenges of the cryptographic technology by providing for systems and techniques that improve the yield of constrained prime numbers and have enhanced resistance to power analysis attacks. Disclosed implementations include constructing a polynomial H(X; u, Q) of a variable X that additionally depend on parameter u and reference value Q. The reference value Q may be an auxiliary prime number whereas parameter u is selected in such a way that the value of the polynomial H(X; u, Q) is not divisible by a set of preselected prime numbers, such as a set of a certain number of low primes {Pᵢ}=3,5, 7, 11, 13, 17, 19, 23 . . . , in one example. This increases the likelihood that a random number X inputted into the polynomial generates a candidate value Z=H(X; u, Q) that is a prime number. Additionally, as disclosed in more detail below, the polynomial H(X; u, Q) may be constructed in such a way that the value Z−1 is divisible by the reference value Q. To ensure that the generated candidate prime numbers are uniformly distributed (or close to being uniformly distributed) across a target range of values, e.g., Z∈[L, H], a set of multiple (e.g., four, six, and/or the like) random values X₁, X₂, . . . . Xₙ may be inputted into the product of the polynomials to generate a candidate prime number

$$Z = {\prod }_{j = 1}^{n} H ( {X}_{j} ; u , Q ) mod {M}^{′}$$

modulo product of the set of prime numbers, M=Πᵢ Pᵢ and the reference value: M′=M·Q, The product of the polynomials ensures that Z−1 is divisible by Q.

The advantages of the disclosed techniques include (but are not limited to) improved likelihood that the generated candidates are prime numbers that automatically satisfy the auxiliary constraint. This shortens the computational time and increases the yield of the prime number generation. The uniformity of the generated candidates facilitates a high degree of protection of prime number generation against cryptanalysis and side-channel attacks.

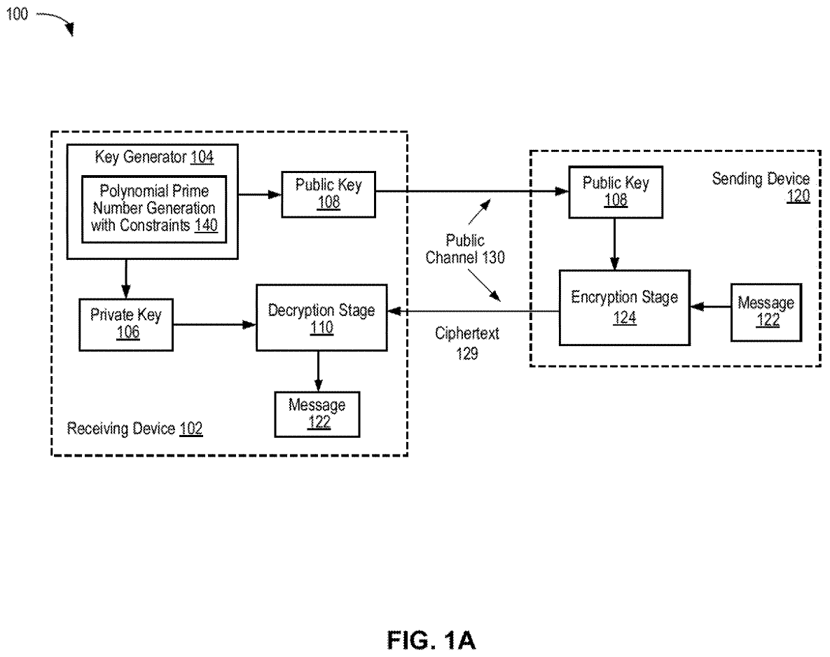

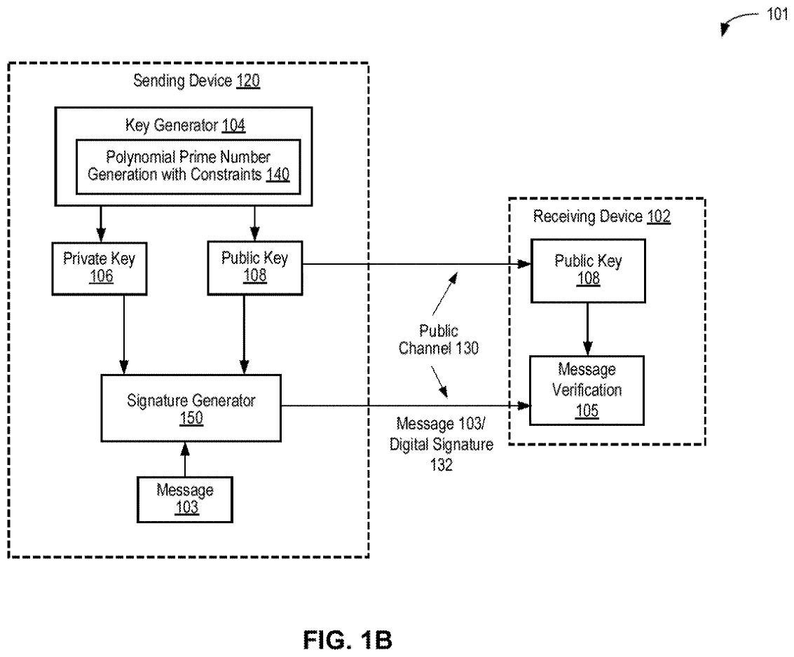

FIG. 1A illustrates an example computing architecture 100 that supports polynomial-based generation of constrained prime numbers in cryptographic applications, in accordance with one or more aspects of the present disclosure. In some implementations, computing architecture 100 implements public/private key cryptographic applications, elliptic curve cryptographic applications, key encapsulation applications, and/or other cryptographic applications. Computing architecture 100 may include various components/modules/applications that are not explicitly depicted in FIG. 1A, including but not limited to various domain-specific applications that perform operations on output or input messages. Computing architecture 100 may include a receiving device 102 deploying a cryptographic application-specific key generator 104 that may generate a private key 106 and a public key 108. Receiving device 102 may provide public key 108 to a sending device 120 that uses public key 108 to encrypt a message 122 before sending ciphertext (encrypted message) 129 over a public communication channel 130, which may include any network, e.g., Internet, local area network, wide area network, and/or the like. In some implementations, message 122 may encapsulate a symmetric key provided to receiving device 102 to establish secure communication between receiving device 102 and sending device 120 over a public communication channel 130. Message 122 may be encrypted by an encryption stage 124 implementing a suitable encryption scheme. In some implementations, the encryption scheme may be one of the post-quantum encryption schemes, including but not limited to Kyber, and/or other similar algorithms.

In some implementations, key generator 104 of receiving device 102 may perform generation of candidate prime numbers and verification (primality testing) whether the generated candidate number are prime numbers, as disclosed in more detail below. In some implementations key generator 104 may deploy polynomial prime number generation with constraints 140, operating as disclosed in more detail below.

Receiving device 102 may process the received ciphertext 129 using decryption stage 110 and recover message 122 using private key 106. Although, for illustration, ciphertext(s) and plaintext(s) (decrypted messages) are generated/processed by different devices in the illustration of FIG. 1A, in some instances ciphertext(s) and plaintext(s) may be generated/processed by the same device. For example, sending device 120 may be the same device as receiving device 102.

Various other cryptographic operations may be performed by receiving device 102 and/or sending device 120 that are not shown in FIG. 1A, including but not limited to masking (obfuscation) of secret data against side-channel attacks, computing hash values, generating shared secret keys, session keys, ephemeral keys, storing secret and public data, fetching secret and/or public data, performing error correction, and/or any other suitable data processing operations.

FIG. 1B illustrates another example computing architecture 101 that supports polynomial-based generation of constrained prime numbers in cryptographic applications, in accordance with one or more aspects of the present disclosure. Computing architecture 101 may implement message authentication using digital signature algorithms, and/or other cryptographic applications. As illustrated in FIG. 1B, sending device 120 may deploy key generator 104 that generates private key 106 and public key 108. Sending device 120 may provide public key 108 to receiving device 102. In some implementations key generator 104 may deploy polynomial prime number generation with constraints 140, operating as disclosed in more detail below. Sending device 120 may include a signature generator 150 that authenticates message 103 using private key 106 or a combination of private key 106 and public key 108.

Sending device 120 may send message 103 together with digital signature 132 produced by signature generator 150 to receiving device 102 over public communication channel 130. Receiving device 102 may use public key 108 to perform message verification 105 to verify digital signature 132. Although, in the illustration of FIG. 1B different devices perform signature generation and signature verification, in some instances both algorithms may be performed by the same device (e.g., with sending device 120 being the same as receiving device 102). Although FIG. 1A and FIG. 1B illustrate various blocks and components that perform operations of the instant disclosure, various additional blocks and components may perform any other suitable cryptographic operations, e.g., masking, splitting into shares, hashing, using Number Theoretic Transforms, Fast Fourier Transforms, and/or any other suitable operations to protect secret data generated, fetched, received, stored, communicated, and/or the like, in conjunction with any suitable cryptographic algorithms that may be deployed on receiving device 102 and/or sending device 120.

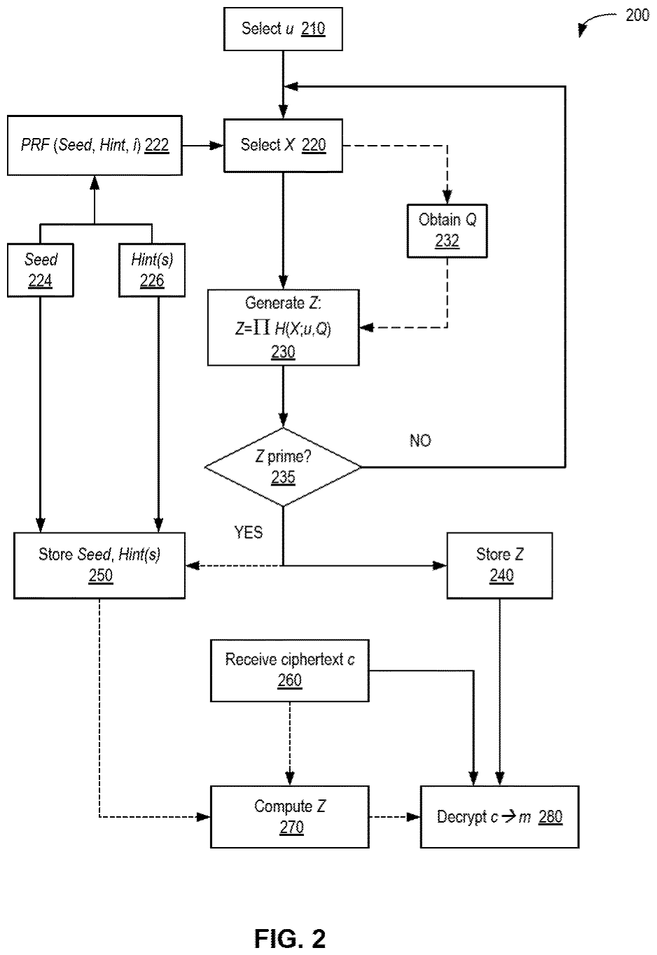

FIG. 2 depicts schematically example operations 200 performed as part of efficient generation of constrained prime numbers and deployment of the generated prime numbers in cryptographic applications, in accordance with one or more aspects of the present disclosure. Disclosed implementations may involve employing polynomial functions for generation of candidate prime numbers. In some implementations, the polynomial functions may be operating on input numbers classified by their residue (e.g., quadratic residue) properties. A quadratic residue A modulo a number P is a number that is congruent to (different by an integer multiple of P from) a square of some number B: A=B² mod P. Conversely, a quadratic nonresidue (QNR) Y modulo P is a number that is not congruent, Y≠X² mod P to a square of any number X. Accordingly, selecting a number −u such that −u≠X² mod P (QNR modulo P) for any number X enables to construct the quadratic polynomial X²+u whose value for any number X is not divisible by P (since by construction X²+u≠0 mod P). A class of polynomials that have no roots modulo a number may be significantly smaller than a class of polynomials that have no roots in the conventional sense. For example, polynomial X²+1 has no integer (or real) root in the conventional sense as no number X turns the value of the polynomial to zero. Yet this polynomial has roots modulo many prime numbers. For example, X=2 is a root of the polynomial X²+1 modulo prime number 5 since 2²+1=5≡0 mod 5; X=5 is a root of the polynomial X²+1 modulo prime number 13 since 5²+1=26≡0 mod 13; X=4 is a root of the polynomial X²+1 modulo prime number 17 since 4²+1=17≡0 mod 17; and/or the like.

For a subset of numbers {Pᵢ}, a processing device performing prime number generation may select a number u (block 210) such that −u #X² mod Pᵢ for any number X and all numbers Pⱼ of the subset of prime numbers. This ensures that the polynomial F(x)=X²+u is not divisible by any number Pᵢ of the subset {Pᵢ}. Likewise, the polynomial G(X)=u·X²+1 is not divisible by any of Pᵢ for any input number X. This follows from the representation G(X)=X²·(Y²+u) where Y≡X⁻¹ mod Pᵢ. Since the value u is so chosen that no Y can make Y²+u divisible by Pᵢ, neither is G(X) divisible by Pᵢ for any X. Based on this property, in some implementations, the subset of prime numbers {Pᵢ} may be chosen to include some (or all) prime numbers up to a target number (e.g., the first 50 prime numbers, the first 100 prime numbers, and so on): {Pᵢ}=2, 3, 5, 7, 11, 13, 17, 19, 23 . . . . In some implementations, the subset of prime numbers {Pᵢ} may be different from the first m prime numbers, as some prime numbers (e.g., 2, in this example) may be excluded while some additional (e.g., larger prime) numbers may be included, and so on. In some implementations, a subset of m prime numbers {Pᵢ} may be randomly sampled form some other set of n prime numbers, e.g., n first prime numbers, n first prime numbers excluding 2, and/or the like. Therefore, selecting an arbitrary number X modulo M=Πᵢ Pᵢ ensures that the number G(X)=u·X²+1 is not divisible by any of Pᵢ. This increases the likelihood that G (X)=u. X²+1 is a prime number, compared with a random selection of potential candidates.

Even though the prime number candidates Z←G(X) generated by polynomial G(X)=u·X²+1 have a significant probability to be prime numbers, they are not yet such that Z−1 is divisible by an auxiliary prime number Q (other by accident that does not occur with any substantial probability).

To ensure that the generated candidate prime numbers satisfy this constraint, an extended modulus M′=M·Q may be defined. (In many applications, it may be expected—though not required—that the reference prime number Q is larger than any of the prime numbers {Pⱼ} that are used in the modulus M=P₁·P₂· . . . ·Pₙ.) A modified polynomial may then be constructed, such as

$$H ( X ) = u \cdot {Q}^{2} \cdot {X}^{2} + 1 ( mod {M}^{′} ) ,$$

where −u is still a quadratic nonresidue (QNR) modulo each of prime numbers {Pⱼ} and the reference prime number Q. A candidate prime number Z generated using the modified polynomial, Z←H(X), is then guaranteed to have the following two properties.
(1) The candidate prime number Z is coprime with M′. This follows from the fact that the polynomial u·X′²+1 with (X′≡Q·X) not being divisible, as explained above, by any of the prime numbers {Pⱼ} or Q (the factors of M′) for any number X′ (which also means—for any X).
(2) The decremented candidate number Z−1 is divisible by the reference prime number Q. This is confirmed by the following transformation (X, being the number used to generate the candidate number Z):

$$Z - 1 ( mod Q ) = u \cdot {Q}^{2} \cdot {X}_{c}^{2} ( mod M \cdot Q ) ( mod Q ) = u \cdot {Q}^{2} \cdot {X}_{c}^{2} ( mod Q ) = 0 ,$$

as the last expressing is clearly divisible by Q.

Even though in the above example, polynomials H(X)=u·Q²·X²+1 (mod M′) are used to generate candidate prime numbers whose decremented value Z−1 is divisible by reference value Q, in other implementations, polynomials H(X)=u·Q²·X²+v (mod M′) may be used to generate candidate prime numbers with value Z-v, decremented by some other predetermined value v (different from 1), being divisible by the reference value Q.

The use of one or more polynomials H(X) speeds up successful constrained prime number generation. Various algorithms may be used to identify numbers −u that are QNR for a set of prime numbers {Pᵢ}, Q. Approximately one half of all numbers are QNR modulo an individual Pᵢ, with another half being QR. Various tests can be used to determine whether a given number uᵢ is a QR or QNR modulo Pᵢ, such as randomly choosing uᵢ within interval [2, Pᵢ−1], calculating

$${u}_{i}^{( {P}_{i} - 1 ) / 2} mod {P}_{i} ,$$

using quadratic reciprocity, and so on. Once a set of individual values uᵢ that are QNR modulo the corresponding prime Pᵢ (or Q) has been determined, a value of u that is QNR modulo each of {Pᵢ}, Q may be calculated using the Chinese Remainder Theorem. Various QNR −u can be precomputed and stored, e.g., in a QNR list in a read-only memory of the processing device that generates prime numbers. In some implementations, if reference prime Q is known beforehand, a set of products u·Q may likewise be precomputed and stored in memory. In those instances where Q is determined as part of a cryptographic application, the products u·Q may be computed on the fly with values u precomputed and stored.

During runtime prime number generation, a number −u (or a number u·Q) may be selected (e.g., randomly) from the stored QNR list and used to form one the polynomial H(X), and/or other similar polynomials. As such, at block 220 (with reference to FIG. 2) a number X_{c} may be selected (e.g., randomly, in some implementations). At block 232, the reference value Q may be obtained (if not known prior to the prime number generation). At block 230, a candidate number Z=H(X)≡(u·Q)²·X²+1 (mod M′) may be generated where extended M′ may be a product of Q and the subset of preselected prime numbers {Pᵢ}: M′=Q·M=Q·Πᵢ Pᵢ. One of primality tests may then be applied (block 235) to the candidate Z, e.g., the Pocklington test, the Baillie-PSW test, the Miller-Rabin test, or the like.

In case the candidate Z fails a primality test, another number X may be selected (e.g., also randomly) and the process repeated until a successful prime number Z is obtained.

The number M′ may serve as the upper number for the candidates (and, therefore, generated primes) and may be selected based on a target size of the desired key. The numbers X used as input into the polynomial function(s) may be selected uniformly from a range [0, Xₘₐₓ−1], which may be the same or different (e.g., smaller or larger) than the range [0, M′−1]. The numbers X may be selected uniformly from the range of X, e.g., with equal likelihood to be selected within different sub-ranges of X. Because QR/QNR are not distributed uniformly, the candidate outputs Z may be distributed with a degree of non-uniformity within the range [0, M′−1]. In some implementations, to ensure the uniformity of candidate outputs Z, additional instances of polynomials may be used.

In some implementations, at block 220, a set of numbers (e.g., random numbers) {Xⱼ} may be generated (e.g., uniformly within the range of X) instead of a single value X. The candidate number may then be generated (at block 430) using a product of k instances (the k-product herein) of the polynomials:

$$Z = {\prod }_{j = 1}^{k} ( {( u \cdot Q )}^{2} \cdot {X}_{j}^{2} + 1 ) ( mod {M}^{′} ) ,$$

With increasing k, the degree of uniformity of the candidate outputs Z increases. In many cryptographic applications, a sufficient (for adequate protection against side-channel attacks) uniformity of output candidates Z may be achieved for k=5 or k=6 instances of polynomial functions. For increased uniformity (and protection), any higher number k>6 may be used. The enhanced uniformity of output may be weighed against an increased amount of computations associated with additional multiplications and operations used to sample additional Xⱼ.

When a computed candidate number Z is an even number, an odd number may be added before the primality testing is performed, for example, M′, or any other predetermined number. In some implementations, the n-product may be modified to output an odd number, e.g., using a modulo 2M arithmetic operation:

$$Z = {\prod }_{j = 1}^{k} ( 4 \cdot {( u \cdot Q )}^{2} \cdot {X}_{j}^{2} + 1 ) + {M}^{′} ) ( mod 2 {M}^{′} ) ,$$

Various other polynomials are withing the scope of the present disclosure that can be used to generate prime number candidates satisfying both (1) the condition of co-primality with M′ and (2) the divisibility of Z−1 by the auxiliary prime q.

In some implementations, e.g., where the predetermine value v is different from 1, and the candidate value is to have the divisibility property Z−v (mod Q), the product of polynomial may be

$$Z = ( v + yQ ) \cdot {\prod }_{j = 1}^{k} ( {( {u}_{j} \cdot Q )}^{2} \cdot {X}_{j}^{2} + 1 ) ( mod {M}^{′} ) ,$$

in which the value y is chosen so that v+yQ is not divisible by any of the primes Pᵢ, and/or a similar product that ensures the desired divisibility of Z−v by Q.

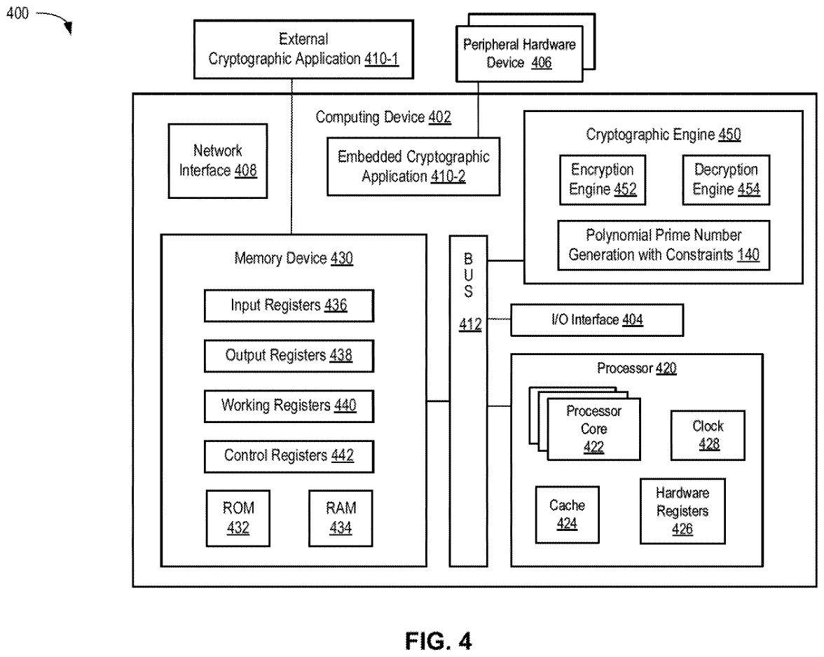

When a computed candidate number Z is determined not to be a prime number, a different set of input numbers {Xᵢ} may be selected and another n-product of polynomials may be computed, as indicated by the NO-loop in FIG. 4. Alternatively, in some implementations, one or more additional numbers Xₖ₊₁, Xₖ₊₂ . . . may be generated and the new candidate number Z* obtained according to

$${Z}^{*} = Z \cdot ( {( u \cdot Q )}^{2} \cdot {X}_{k + 1}^{2} + 1 ) \cdot ( {( u \cdot Q )}^{2} \cdot {X}_{k + 2}^{2} + 1 ) \cdot … ( mod {M}^{′} ) .$$

In some implementations, depending on the desired size of the prime numbers, a lower bound L (and, similarly, an upper bound H) may be set for the target range of Z. In some implementations, the lower bound may be a soft bound, with the candidate numbers that are below (but not significantly below) the lower bound deemed acceptable. Similarly, in some implementations, the candidate numbers that are above (but not significantly above) the lower bound may still be excluded. In one illustrative example, after the candidate number Z is determined, a modified candidate number Z_{L} may be computed as follows:

$${Z}_{L} = L + ( Z - L mod {M}^{′} ) ,$$

ensuring that Z_{L}∈[L, M′+L−1]. In some implementations, L may be comparable to M′ (e.g., by an order of magnitude). In some implementations, L can be a multiple of M′, pushing the interval [L, M′+L−1] to values that are outside (and do not overlap with) the interval [0, M′−1]. In some implementations, a larger range can be obtained by taking L to be a random multiple of M′: L=R·M′ where a random number R may be taken within a predefined interval corresponding to a desired (target) range of prime numbers. In some implementations, the random number R can be selected once for a particular instance of the prime number being generated and reused for all attempts to obtain this prime number (with other random numbers R selected when additional prime numbers are sought). In some implementations, the random number R can be resampled for each attempt (e.g., each application of the n-product) to obtain the prime number.

In some implementations, to ensure that the candidate numbers are odd, an adjustment Z_{L}←Z may be performed via (or a similar) transformation:

$${Z}_{L} = L + 2 \cdot ( Z - L mod {M}^{′} ) + 2 R \cdot {M}^{′} ,$$

where a random number is sampled from the interval

$$R ∈ ( 0 , ⌊ \frac{H - L}{2} ⌋ ) .$$

In some implementations, modular operations may be performed using Montgomery multiplication that replaces division by the modulus (e.g., M′) with a Montgomery reduction operation, which amounts to adding an appropriately chosen multiple of M′ until the result is a multiple of an auxiliary Montgomery modulus and thus amenable to a simple transformation (e.g., cancellation the low bits of the result).

In some implementations, generation of the set of numbers {Xⱼ} may be performed using one or more pseudorandom functions (PRF), e.g., a function which generates outputs deterministically (so that the same inputs generate the same inputs), while the outputs appear similar to random numbers (block 222). A PRF may use a seed number Seed (block 224), an identifier j (e.g., enumerator) of the number X being generated and a hint Hint (block 226) that may change (deterministically or randomly) between different attempts (applications of the n-product) in generating the prime number:

$${X}_{j} = PRF ( Seed , j , Hint ) .$$

In some implementations, Seed may be a longer number (e.g., a 128-bit number, a 256-bit number, and the like), whereas Hint may be a shorter number (e.g., a 16-bit number, a 32-bit number, and the like). The inputs Seed and Hint may be stored as a secret information and may be protected, during execution of PRF( ) using various methods of blinding, masking, or other types of cryptographic protection.

In some implementations, Seed may be generated randomly, for each prime number generating session, for each particular time period, each time the processing device is powered on, and so on. Seed may be generated from a hardware key, such as a PUF (physical unclonable function) key that is based on manufacturing characteristics of a hardware device. Upon a successful prime number identification using the methods disclosed above, as depicted by dashed arrows in FIG. 2, at block 250, the processing device may store Seed and Hint (and, optionally, if one or more additional numbers Xₖ₊₁, Xₖ₊₂ . . . were employed—the total number kₘₐₓ of the numbers X used in the polynomial product) whereas the actual generated prime number (p and/or q) may not be stored (e.g., for additional protection of secret information). Respectively, when a ciphertext c is received (block 260), the processing device may access stored Seed, Hint (and, optionally, iₘₐₓ) and generate the set {Xⱼ} using PRF( ). Based on the generated set {Xⱼ}, the processing device can recover, applying the polynomial product to the set {Xⱼ} (or kₘₐₓ-product, if kₘₐₓ>n) to recover the prime number (block 270) and decrypt the encrypted message (block 280). A similar process may be used to reproduce other prime numbers of the cryptographic key, and/or any additional prime numbers as may be used by the decryption algorithm. For example, to reproduce multiple prime numbers, e.g., p, q . . . , a single Seed and multiple hints may be stored, e.g., Hint₁, Hint₂ . . . . In some implementations, a single Seed and a single hint, e.g., Hint₁, may be stored whereas other hints Hint₂ . . . may be deterministically determined based on Hint₁. In some implementations, as depicted by solid arrows in FIG. 2, the generated prime numbers may be stored directly (block 240) and used for decryption of a received ciphertext (block 280).

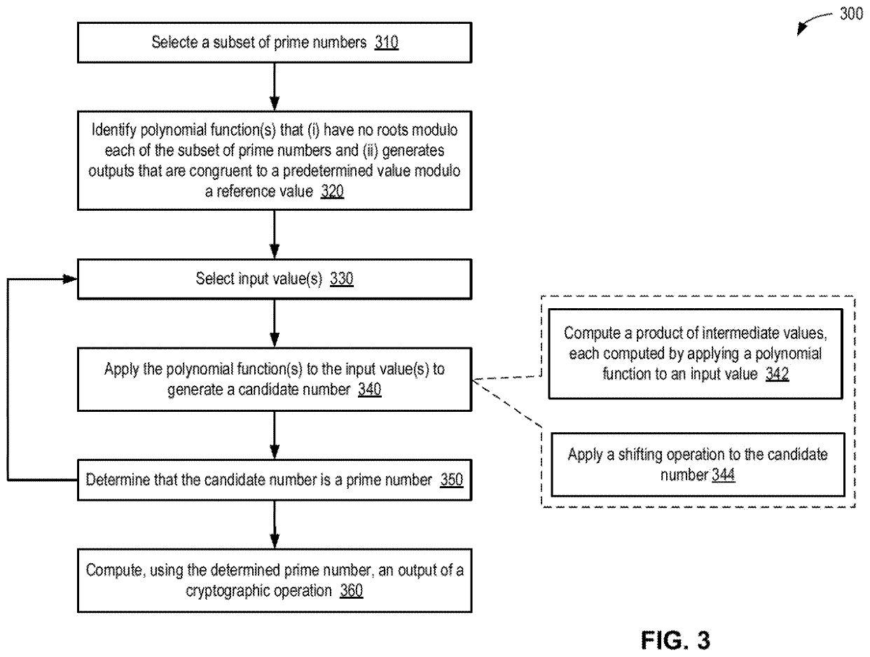

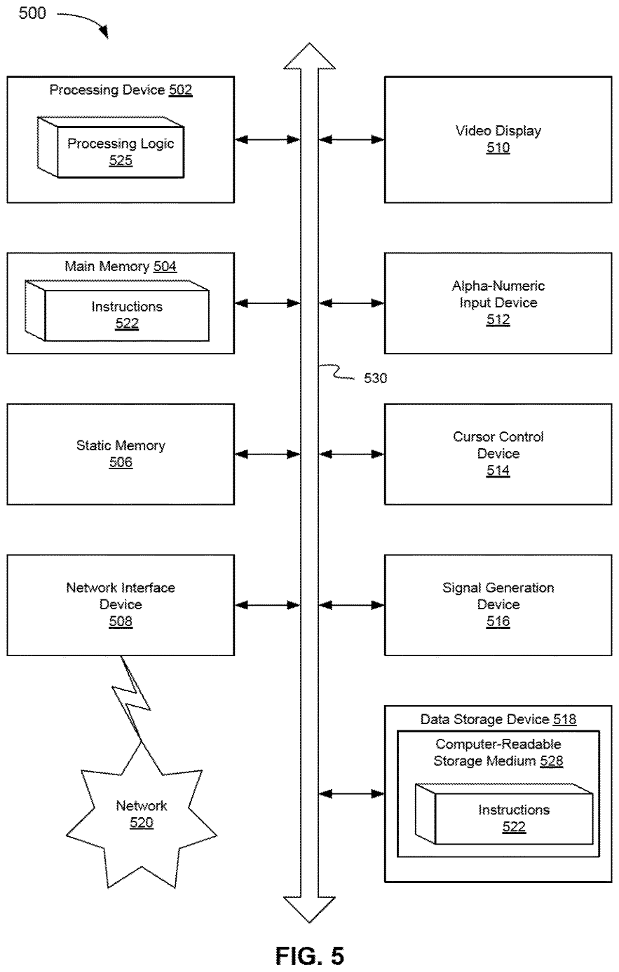

FIG. 3 depicts a flow diagram of an illustrative method 300 of efficient generation of constrained prime numbers and deployment of the generated prime numbers in cryptographic applications, in accordance with one or more aspects of the present disclosure. Method 300 and/or each of its individual functions, routines, subroutines, or operations may be performed by one or more processing units of the computing system implementing the method, (e.g., processor 420 in FIG. 4 and/or processing device 502 in FIG. 5). In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). Alternatively, the processing threads implementing method 300 may be executed asynchronously with respect to each other. Various operations of method 300 may be performed in a different order compared to the order shown in FIG. 3. Some blocks may be performed concurrently with other blocks. Some blocks may be optional. At least some of the blocks of method 300 may be performed by polynomial prime number generation with constraints 140 component of a processing device (with reference to FIGS. 1-2 and FIG. 3).

A processor device implementing method 300 may include an arithmetic logic unit, an FPGA, and the like, or other suitable processing logic, hardware or software or a combination thereof. In some implementations, method 300 may be performed to process an input into a cryptographic operation. In some implementations, the cryptographic operation may include a digital signature operation, a plaintext encryption operation, a ciphertext decryption operation, a key encapsulation operation, and/or the like. The processing device performing the cryptographic operation may generate a private key/public key pair that includes two or more prime numbers. For example, method 300 may involve receiving an encrypted message c (ciphertext) from a sending device (e.g., sending device 120, with reference to FIG. 1A). Prime numbers may be generated when the cryptographic application is set up and/or at regular time intervals, when the previous key has become compromised as a result of a power-analysis attack, a security breach, and so on. In some implementations, the private key may include three or more prime numbers.

The processing device implementing method 300 may use a subset of prime numbers as part of a new cryptographic key. At block 310, the processing device may select a subset of prime numbers, e.g., a subset that includes {Pᵢ}=P₁, P₂, . . . . Pₙ, such as the lowest prime numbers up to a certain target prime number (e.g., the first n prime numbers excluding number 2, in one example non-limiting implementation). Additionally, the subset of prime numbers may include a reference value Q. At block 320, method 300 may include identifying one or more polynomial functions that (i) have no roots modulo each prime number of the selected subset of prime numbers and (ii) generate outputs that are congruent to a predetermined value (e.g., value v, which may be v=1, in some implementations). In some implementations, each of the one or more polynomial functions may generate outputs that are congruent to the predetermined value modulo the reference value (equal to the predetermined value v or different from the predetermined value v by an integer number of the reference values) for all inputs into a respective polynomial function of the one or more polynomial functions. For example, the polynomial function Hᵢ(X)=uᵢ·Q²·X²+v (mod M′) is congruent to v for all inputs X, as disclosed in more detail in conjunction with FIG. 2. In some implementations, modulus M and/or extended modulus M′ (and/or the subset of prime numbers {Pᵢ}) may be precomputed and stored in memory.

In some implementations, the processing device may select one or more parameter values (e.g., −u₁, −u₂, −u₃ . . . ) that are quadratic non-residues modulo each of the selected subset of prime numbers and use the selected parameter values to construct the polynomial functions, e.g., Hᵢ(X)=uᵢ·Q²·X²+v or Hᵢ(X)=uᵢ·q²·X²+1. As such, the one or more polynomial functions may be a quadratic function associated with a first coefficient (e.g., uᵢ·Q²) determined using (i) a quadratic nonresidue (e.g., uᵢ) modulo each of the selected subset of prime numbers, and (ii) the reference value (e.g., Q), and a second coefficient determined using the predetermined value (e.g., v).

At block 330, method 300 may continue with selecting one or more input values {Xⱼ} In some implementations, the input values may be selected randomly within a predetermined interval. In some implementations, the input values may be selected using a respective (different for each j) output of a pseudorandom function. The respective j-th output of the pseudorandom function may be determined in view of one or more stored values, e.g., seed value Seed and a respective hint value Hintⱼ. The seed value may be common to all instances k of selection of the input value Xⱼ whereas the hint numbers may be different for different j. In some implementations, both the hint value and the seed value change with every j when a new value Xⱼ is being selected.

At block 340, method 300 may continue with the processing device applying the one or more polynomial functions to the one or more input values to generate a candidate number Z. In some implementations, applying the one or more polynomial functions to the one or more input values to generate the candidate number may include operations illustrated with the callout portion of FIG. 3. More specifically, at block 342, method 300 may include computing a product of a plurality of intermediate values, e.g.

$${u}_{i} \cdot {Q}^{2} \cdot {X}_{j}^{2} + v .$$

Each intermediate value of the plurality of intermediated values may be computed by applying a polynomial function (e.g., Hᵢ(X)=uᵢ·Q²·X²+v) of the one or more polynomial functions to an input value (e.g., Xⱼ) of the one or more input values. In some implementations, a given polynomial function (e.g., H₁(X)=u₁·Q²·X²+v) may be applied to one input value (e.g., X₁). In some implementations, any, some, or all polynomial functions (e.g., H₁(X)=u₁·Q²·X²+v) may be applied to multiple input values (e.g., H₁(X) may be applied to X₁, X₂, H₂(X) may be applied to X₃, X₄, X₅, and so on). In some implementations, the product of the plurality of intermediate values is computed modulo a modulus number (e.g., extended modulus M′) that is divisible by each of the subset of prime numbers For example, the modulus number may be a product of the predefined set of prime numbers, Πᵢ Pᵢ (but may also include additional factors, e.g., Q). The number of instances kₘₐₓ of polynomial function(s) may be arbitrary, e.g., in some implementations, the number of instances may be four, five, or more. In some implementations, the product of the plurality of intermediate values is computed using Montgomery multiplication techniques.

In some implementations, operations of method 300 may include, at block 344, applying a shifting operation to the candidate number. For example, in those instances where the candidate number Z is even, a suitable odd number (e.g., modulus M or extended modulus M′) may be added to (or subtracted from) the candidate number, e.g., Z←Z+M′. In some implementations, the candidate number Z may undergo a shifting operation to bring the candidate number to a target range of values, e.g., above a target lower bound L, such as Z←(Z−L mod M′)+L+R·M′, where R may be a random number.

At block 350, method 300 may continue with the processing device determining, using any suitable methods, that the candidate number Z is a prime number. In some implementations, the determined prime numbers, e.g., p and q, may be used to generate the product p·q that is published (or transmitted) as part of the public key, whereas the values p and q may not be stored.

In some instances, the successful candidate number Z may not be the first candidate number generated using the set of input numbers {Xⱼ}. For example, the set of initial input numbers {Xⱼ} may first be used to generate an initial (unsuccessful) candidate number using initial instances of the polynomial function(s) as described above, e.g., by multiplying the product of each of the one or more initial instances of the polynomial function(s). Accordingly, once it is determined that the initial candidate number is not a prime number, the product of the initial instances of the polynomial function(s) may be multiplied by one or more additional instances of the polynomial function (as applied to one or more additional input numbers Xⱼ).

At block 360, method 300 may continue with the processing device computing, using the determined prime number, an output of a cryptographic operation. In some implementations, the output of the cryptographic operation may include a digital signature for an input into the cryptographic operation, an encryption of the input into the cryptographic operation, a decryption of the input into the cryptographic operation, and/or the like. For example, the processing device may receive the (ciphertext) input c and decrypt c to obtain message m. The decryption operation may be performed using the previously determined prime number(s), e.g., p and q, by computing (recovering). In some implementations, the operations of blocks 310-350 may be used as part of generation of finite-field Diffie-Hellman parameters. In some implementations, the operations of blocks 310-350 may be used as part of generation of RSA keys with provable prime numbers p and q.

FIG. 4 is a block diagram illustrating an example computing platform 400 capable of supporting of efficient generation of constrained prime numbers and deployment of the generated prime numbers in cryptographic applications, in accordance with one or more aspects of the present disclosure. Example computing device 400 may be or include a desktop computer, a tablet, a smartphone, a server (local or remote), a thin/lean client, and the like. Example computing platform 400 may be a smart card reader, a wireless sensor node, an embedded system dedicated to one or more specific applications (e.g., cryptographic applications 410-n), and so on. Example computing platform 400 may include (but need not be limited to) a computing device 402 having one or more processors 420 (e.g., central processing units (CPUs)) capable of executing binary instructions, and one or more memory devices 430. Herein “processor” or “processing device” refers to a device capable of executing instructions encoding arithmetic, logical, or I/O operations. In one illustrative example, a processing device may follow von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Computing device 402 may include an input/output (I/O) interface 404 to facilitate connection of computing device 402 with peripheral hardware devices 406, such as card readers, terminals, printers, scanners, internet-of-things devices, and the like. Computing device 402 may further include a network interface 408 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computing device 402. For example, network interface 408 may be used to support a connection to receiving device 102 and/or sending device 120 of FIGS. 1A-1B. Various hardware components of computing device 402 may be connected via a bus 412, which may have its own logic circuits.

Example computing platform 400 may support one or more cryptographic applications 410-n, such as one or more external cryptographic applications 410-1 and/or one or more embedded cryptographic applications 410-2. Cryptographic applications 410-n may be secure authentication applications, public key signature applications, key encapsulation applications, key decapsulation applications, encryption applications, decryption applications, fully homomorphic encryption/decryption applications, secure storage applications, and so on. External cryptographic application 410-1 may be instantiated on the same computing device 402, e.g., by an operating system executed by the processor 420 and residing in a memory device 430. Alternatively, external cryptographic application 410-1 may be instantiated by a guest operating system supported by a virtual machine monitor (hypervisor) executed by the processor 420. In some implementations, external cryptographic application 410-1 may reside on a remote access client device or a remote server (not shown), with the computer device 402 providing cryptographic support for the client device and/or the remote server.

Processor 420 may include one or more processor cores 422 having access to cache 424 (e.g., a single-level or multi-level cache) and one or more hardware registers 426. In some implementations, each processor core 422 may execute instructions to run a number of hardware threads, also known as logical processors. Various logical processors (or processor cores) may be assigned to one or more cryptographic applications 410-n, although more than one processor may be assigned to a single cryptographic application for parallel processing. Memory device 430 may refer to a volatile or non-volatile memory and may include a read-only memory (ROM) 432, a random-access memory (RAM) 434, as well as (not shown) electrically erasable programmable read-only memory (EEPROM), flash memory, flip-flop memory, or any other device capable of storing data. RAM 434 may be a dynamic random-access memory (DRAM), synchronous DRAM (SDRAM), a static memory, such as static random access memory (SRAM), and the like.

Memory device 430 may include one or more registers, such as one or more input registers 436 to store cryptographic keys, input polynomials, and other data for cryptographic applications 410-n. Memory device 430 may further include one or more output registers 438 to store outputs of cryptographic application, and one or more working registers 440 to store various intermediate values generated in the course of performing cryptographic computations, including masking operations. Memory device 430 may also include one or more control registers 442 for storing information about modes of operation, selecting a cryptographic algorithm, initializing cryptographic computations, selecting a masking mode, selecting ring Za, performing masking and reverse decomposition, and/or the like. Control registers 442 may communicate with one or more processor cores 422 and a clock 428, which may keep track of a processing operation (e.g., one of operations of FIG. 2) being performed. In some implementations, registers 436-442 may be implemented as part of RAM 434. In some implementations, some or all of the registers 436-442 may be implemented separately from RAM 434. Some of or all registers 436-442 may be implemented as part of processor 420 (e.g., as part of the hardware registers 426). In some implementations, processor 420 and memory device 430 may be implemented as a single field-programmable gate array (FPGA).

Computing device 402 may include a cryptographic engine 450 to support cryptographic operations of processor 420. Cryptographic engine 450 may be configured to facilitate encryption operations, decryption operation, digital signature operations, key encapsulation operations, and/or any other applicable cryptographic operations, in accordance with implementations of the present disclosure. As depicted in FIG. 4, cryptographic engine 450 may be a separate hardware component, e.g., an accelerator. In some implementations, cryptographic engine 450 may be implemented as a software (or firmware) module instantiated in memory device 430. In some implementations, cryptographic engine 450 may be partially implemented as a hardware component and partially as a software (or firmware) module. Cryptographic engine 450 may include an encryption engine 452 to encrypt plaintext messages and generate ciphertexts. Cryptographic engine 450 may also include a decryption engine 454 to decrypt ciphertexts and recover plaintext messages. Encryption engine 452 and/or decryption engine 454 may use a deploy polynomial prime number generation with constraints 140 for efficient implementation of cryptographic applications, e.g., as described in more detail in conjunction with FIGS. 1A-1B and FIGS. 2-3 above.

FIG. 5 depicts a block diagram of an example computer system 500 operating in accordance with one or more aspects of the present disclosure. In various illustrative examples, computer system 500 may represent receiving device 102, sending device 120 (with reference to FIGS. 1A-1B), and/or computer device 402 (with reference to in FIG. 4). Computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), which may include processing logic 525, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing method 300 of efficient generation of constrained prime numbers and deployment of the generated prime numbers in cryptographic applications.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing method 300 of efficient generation of constrained prime numbers and deployment of the generated prime numbers in cryptographic applications n.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
selecting a subset of prime numbers;
identifying, by a processing device, one or more polynomial functions that (i) have no roots modulo each prime number of the selected subset of prime numbers and (ii) generate outputs that are congruent to a predetermined value modulo a reference value;
selecting, by the processing device, one or more input values;
applying, by the processing device, the one or more polynomial functions to the one or more input values to generate a candidate number;
determining, by the processing device, that the candidate number is a prime number; and
computing, by the processing device and using the determined prime number, an output of a cryptographic operation.

2. The method of claim 1, wherein the one or more polynomial functions comprise a quadratic function associated with:
a first coefficient determined using (i) a quadratic nonresidue modulo each of the selected subset of prime numbers, and (ii) the reference value, and
a second coefficient determined using the predetermined value.

3. The method of claim 1, wherein a number of the one or more input values is at least four.

4. The method of claim 1, wherein applying the one or more polynomial functions to the one or more input values to generate the candidate number comprises:
computing a product of a plurality of intermediate values, each intermediate value of the plurality of intermediated values computed by applying a polynomial function of the one or more polynomial functions to an input value of the one or more input values.

5. The method of claim 4, wherein the product of the plurality of intermediate values is computed modulo a modulus number divisible by each of the subset of prime numbers.

6. The method of claim 5, wherein the product of the plurality of intermediate values is computed using Montgomery multiplication.

7. The method of claim 1, wherein the one or more input values are selected within a predetermined interval using a pseudorandom function in view of one or more stored values.

8. The method of claim 1, wherein the predetermined value is a unit value.

9. The method of claim 1, wherein the reference value comprises a prime number different from each prime number of the subset of prime numbers.

10. The method of claim 1, wherein each of the one or more polynomial functions generate outputs that are congruent to the predetermined value modulo the reference value for all inputs into a respective polynomial function of the one or more polynomial functions.

11. The method of claim 1, wherein the output of the cryptographic operation comprises at least one of:
a digital signature for an input into the cryptographic operation,
an encryption of the input into the cryptographic operation, or
a decryption of the input into the cryptographic operation.

12. A system comprising:
a memory device; and
a processing device communicatively coupled to the memory device, the processing device to:
select a subset of prime numbers;
identify one or more polynomial functions that (i) have no roots modulo each prime number of the selected subset of prime numbers and (ii) generate outputs that are congruent to a predetermined value modulo a reference value;
select one or more input values;
apply the one or more polynomial functions to the one or more input values to generate a candidate number;
determine that the candidate number is a prime number; and
compute, using the determined prime number, an output of a cryptographic operation.

13. The system of claim 12, wherein the one or more polynomial functions comprise a quadratic function associated with:
a first coefficient determined using (i) a quadratic nonresidue modulo each of the selected subset of prime numbers, and (ii) the reference value, and
a second coefficient determined using the predetermined value.

14. The system of claim 12, wherein to apply the one or more polynomial functions to the one or more input values to generate the candidate number, the processing device is to:
compute a product of a plurality of intermediate values, each intermediate value of the plurality of intermediated values computed by applying a polynomial function of the one or more polynomial functions to an input value of the one or more input values.

15. The system of claim 14, wherein the product of the plurality of intermediate values is computed modulo a modulus number divisible by each of the subset of prime numbers.

16. The system of claim 15, wherein the product of the plurality of intermediate values is computed using Montgomery multiplication.

17. The system of claim 12, wherein the one or more input values are selected within a predetermined interval using a pseudorandom function in view of one or more stored values.

18. The system of claim 12, wherein the reference value comprises a prime number different from each prime number of the subset of prime numbers.

19. The system of claim 12, wherein the output of the cryptographic operation comprises at least one of:
a digital signature for an input into the cryptographic operation,
an encryption of the input into the cryptographic operation, or
a decryption of the input into the cryptographic operation.

20. A non-transitory computer-readable medium storing instructions thereon, wherein the instructions, when executed by a processing device performing a cryptographic operation, cause the processing device to:
select a subset of prime numbers;
identify one or more polynomial functions that (i) have no roots modulo each prime number of the selected subset of prime numbers and (ii) generate outputs that are congruent to a predetermined value modulo a reference value;
select one or more input values;
apply the one or more polynomial functions to the one or more input values to generate a candidate number;
determine that the candidate number is a prime number; and
compute, using the determined prime number, an output of a cryptographic operation.
